(19) United States
(12) Patent Application Publication
(10) Pub. No.: US 2001/0025268 A1
(43) Pub. Date: Sep. 27, 2001

(54) Method for brokering freight transportation routes and warehousing space

(76) Inventor: Jeffrey W. Hnat, Pittsburgh, PA (US)

Correspondence Address: Russell D. Orkin, WEBB ZIESENHEIM LOGSDON ORKIN & HANSON, P.C., 700 Koppers Building, 436 Seventh Avenue, Pittsburgh, PA, 15219-1818, US

(21) Appl. No.: 09/758,794

(22) Filed: Jan. 11, 2001

Related U.S. Application Data
(60) Provisional application No. 60/175,612, filed on Jan. 11, 2000.

(51) Int. Cl. G06F 17/60

(52) U.S. Cl. 705/37

(57) ABSTRACT

On-line auctioning of transportation routes and warehouse services enables prospective transportation buyers to post their transportation needs on the Internet. Transportation providers can bid through an on-line auctioning process, the price and routes or lanes that they are willing to service. Transportation buyers will be able to review the bids on-line and select the appropriate transportation provider that best suits their needs. Transportation providers can also bid, through an on-line auctioning process, the price they are willing to provide transportation services to a transportation buyer. Warehouse needs and available warehouse space can also be auctioned on-line.

### CROSS REFERENCE TO RELATED APPLICATION

This application claims priority from U.S. Provisional Patent Application Ser. No. 60/175,612, filed Jan. 11, 2000, entitled “Method and Apparatus for Brokering Freight Transportation Routes and Warehousing Space”.

### BACKGROUND OF THE INVENTION

For purpose of this application, a transportation buyer (TB) is defined as a person, company, or other entity that needs its products warehoused or transported via truck, plane, boat or train between locations. A transportation provider (TP) is defined as a person, company, or other entity that provides warehousing or transportation services via truck, plane, boat or train between locations. The above needs and services will be referred to in broad terms as “transportation needs” (the word need or needs may be used interchangeably throughout this application in both the singular and plural context). A “transportation need” may be referred to as a “transportation capability” when referencing a TP.

The current system or process in which TBs and TPs transact business is very cumbersome and inefficient. This inefficiency stems from a business process that essentially has remained unchanged for decades.

Generally TBs have long-term and short-term transportation/warehouse needs. A long-term need typically involves a commitment from a TP to provide transportation services over a specific period of time. For example, XYZ trucking company, a TP, will agree to service the transportation needs of a TB company covering predetermined lanes over a two-year period. A short-term need may involve transporting TB's excess inventory (not covered by an existing transportation contract) between two locations, e.g., between Pittsburgh, PA and Cleveland, OH, by tomorrow.

The current process for a TB to acquire the long-term services of a TP is typically accomplished through the following steps:

1) The TB begins by acquiring information regarding potential TPs that may be able to meet their transportation needs. The TB will typically determine who the potential TPs are through (i) referrals from other TBs; (ii) prior experience with TPs; (iii) review of trade publications and other industry literature; (iv) web sites of TPs; and/or (v) contact with a TP's salesman.

2) After acquiring this information, the TB will mail one or more TP's a “Request for Information” regarding the TP's qualifications. The information requested often includes information concerning the TP's fleet information, transportation service availability, number of drivers and other relevant information.

3) The information requests returned by each TP are evaluated by the TB to determine if they are qualified.

4) The TB then notifies each qualified TP that they have met the TB's prequalification criteria.

5) The TB then provides each qualified TP with a bid package that contains shipping requirements between various locations throughout the world.

6) Each qualified TP will then submit a bid on the lanes, i.e., shipping routes, that they are able to provide transportation services.

7) The TB will then analyze the various bid packages submitted by each qualified TP to determine the best combination of qualified TP's to meet their transportation needs while minimizing transportation costs.

8) The TB will then notifies each qualified TP which lanes they have been awarded. Each TP awarded one or more lanes may only be awarded part of the lanes submitted in its bid. Since a TP often bids a price based on the assumption that all lanes included in its bid will be awarded, if only a few lanes are awarded, the TP may withdraw from the process due to the higher costs associated with only servicing a few lanes. This withdrawal often forces the TB to reanalyze the remaining bids repeatedly until all the lanes have been accepted by qualified TPs.

The current process for a TB to obtain short-term services of a TP is typically accomplished through the following steps: (i) the TB makes cold calls to various TPs, preferably in the geographic area of the TB; (ii) the TB contacts a TB transportation broker who contacts various TPs to fill TBs need; and/or (iii) the TB uses an existing TP as an add-on to existing transportation contract.

The process of obtaining short-term transportation needs can be costly for a TB because the TB will often pay a premium to fill the need. Due to the time constraints associated with a short-term need, the TB will contact a transportation broker. For example, the TB will contact the broker and explain that they need freight moved from Pittsburgh, PA to Miami, FL and are willing to pay $ 1.20 per mile. The broker will then contact TP's by telephone and inquire whether they can move freight from Pittsburgh, PA to Miami, FL for less than $1.20 per mile, e.g., $0.90 per mile. The broker continues this process until they find the lowest priced TP that satisfies the TB's requirements. The broker then keeps as a commission the difference, e.g., $0.30 per mile, between the rate the TB is willing to pay and rate the TP agrees to move the freight.

If an Internet-based transportation auction method was available, the TB could post his transportation needs on the Internet. TPs would then bid directly on the TB's transportation need without having to use a freight broker as a middle man between the TP and the TB. In the above example for moving freight between Pittsburgh, Pa. and Miami, Fla., this bid could be as low as $0.40 a mile because a Miami-based TP has an empty truck in Pittsburgh, PA. In this case, the Miami-based TP would rather be paid $0.40 a mile than drive an empty truck from Pittsburgh, Pa. to Miami, Fla. Using the same example, the broker in Pittsburgh did not know about the TP in Miami, Fla. or that the Miami TP had an empty truck in Pittsburgh, Pa. The use of an Internet-based transportation auction method would have saved the TB $0.80 per mile, i.e., $1.20-$0.40, and saved the fuel associated with two trucks driving from Pittsburgh, Pa. to Miami, Fla.

The current process for a TP to obtain transportation/warehouse business is accomplished through (i) the TP making “cold calls” to TBs; (ii) use by the TP of a salesman to make inquires of TBs by referral/networking; (iii) the TP's identity, i.e., potential TBs seeing equipment with the TP's name; (iv) cross-selling off current customer base; (v) visual through TP's Internet home pages; and/or (vi) TB trade publications and other literature.

From the TP's standpoint, there is no efficient mechanism for notifying the TBs that they have excess capacity in certain lanes. For example, a TP may have transported goods from Pittsburgh, Pa. to San Francisco, Calif. The next pick-up may be in Las Vegas, Nev. The TP's truck will be empty from San Francisco, Calif. to Las Vegas, Nev. Using an Internet-based transportation auction method, the TP could post the fact that this route is available at a low cost per mile. Using the Internet-based transportation auction method, a TB based in San Francisco, Calif., who typically ships freight to Las Vegas, Nev., could accept the TP's bid for that route.

### SUMMARY OF INVENTION

Accordingly, I have invented a method of brokering freight transportation routes. The method includes receiving at a server computer from a computer of a transportation provider (TP) an available transportation capability of the TP. The server computer also receives from a computer of a transportation buyer (TB) a transportation need of the TB. The server computer compares the available transportation capability of the TP and the transportation need of the TB. A determination is made if the available transportation capability of the TP fulfills the transportation need of the TB. If the available transportation capability of the TP fulfills the transportation need of the TB, the available transportation capability of the TP is transmitted from the server computer to the computer of the TB. In response to receiving the available transportation capability of the TP, a bid is transmitted from the computer of the TB to the server computer for the available transportation capability of the TP. The bid is forwarded from the server computer to the computer of the TP wherein, in response to receiving the bid from the server computer, a bid acceptance is transmitted from the computer of the TP to the server computer.

The method can also include transmitting a confirmation of the bid acceptance from the server computer to the computer of the TB and preparing at the server computer a bid acceptance contract from data, such as boilerplate contract provisions and at least the names of the TB and the TP, stored at the server computer. The bid acceptance contract can then be transmitted from the server computer to the computers of the TB and the TP.

The step of determining if the available transportation capability of the TP fulfills the transportation need of the TB includes comparing the available transportation capability of the TP and the transportation need of the TB based on at least one predetermined rule. The available transportation capability of the TP will be determined to fulfill the transportation need of the TB when the at least one rule is satisfied even when there is not a direct match between the available transportation capability of the TP and the transportation need of the TB.

I have also invented a method of brokering freight transportation routes that includes receiving at a server computer from a computer of a TP an available transportation capability of the TP and receiving at the server computer from a computer of a TB a transportation need of the TB. The server computer compares the available transportation capability of the TP and the transportation need of the TB and determines if the transportation need of the TB is fulfilled by the available transportation capability of the TP. If so, the transportation need of the TB is transmitted from the server computer to the computer of the TP. In response to receiving the transportation need of the TB, a bid is transmitted from the computer of the TP to the server computer for the transportation need of the TB. The bid is forwarded from the server computer to the computer of the TB wherein, in response to receiving the bid from the server computer, a bid acceptance is transmitted from the computer of the TB to the server computer.

The method can also include transmitting confirmation of the bid acceptance from the server computer to the computer of the TP. A bid acceptance contract can be prepared at the server computer from data, such as boilerplate contract provisions and at least the names of the TB and the TP, stored at the server computer. The bid acceptance contract can be transmitted from the server computer to the computers of the TB and the TP.

At least one predetermined rule can be utilized to determine that the available transportation capability of the TP fulfills the transportation need of the TB even when there is not a direct match therebetween.

I have also invented a method of brokering a warehouse space that includes receiving at a server computer from a computer of a warehouse space provider (WSP) an available warehouse space capability and receiving at the server computer from a computer of a warehouse space buyer (WSB) a warehouse space need. The available warehouse space capability of the WSP and the warehouse space need of the WSB are compared to determine if the available warehouse space capability fulfills the warehouse space need. If so, the available warehouse space capability of the WSP is transmitted from the server computer to the computer of the WSB. In response to receiving the available warehouse space capability of the WSP, a bid for the available warehouse space of the WSP is transmitted from the computer of the WSB to the server computer. The bid is forwarded from the server computer to the computer of the WSP wherein, in response to receiving the bid, a bid acceptance is transmitted from the computer of the WSP to the server computer.

The method can also include transmitting a confirmation of the bid acceptance from the server computer to the computer of the WSB in response to the server computer receiving the bid and preparing a bid acceptance contract from data, such as boilerplate contract provisions and at least the names of the WSB and the WSP, stored at the server computer. The bid acceptance contract can then be transmitted from the server computer to the computers of the WSB and the WSP.

At least one predetermined rule can be utilized to determine if the available warehouse space capability of the WSP fulfills the warehouse space need of the WSB even when there is not a direct match therebetween.

Lastly, I have invented a method of brokering a warehouse space that includes receiving at a server computer from a computer of a WSP an available warehouse space capability and receiving at the server computer from a computer of a WSB a warehouse space need. The available warehouse space capability and the warehouse space need are compared to determine if the available warehouse space need is fulfilled by the available warehouse space capability. If so, the warehouse space need is transmitted from the server computer to the computer of the WSP. In response to receiving the warehouse space need, a bid for the warehouse space need is transmitted from the computer of the WSP to the server computer. The bid is then forwarded from the server computer to the computer of the WSB wherein, in response to receiving the bid from the server computer, a bid acceptance is transmitted from the computer of the WSB to the server computer.

The method also includes transmitting a confirmation of the bid acceptance from the server computer to the computer of the WSP in response to the server computer receiving the bid and preparing a bid acceptance contract from data, such as boilerplate contract provisions and the names of the WSB and the WSP, stored at the server computer. The bid acceptance contract can then be transmitted from the server computer to the computers of the WSB and the WSP.

At least one predetermined rule can be utilized to determine if the available warehouse space capability fulfills the warehouse space need when there is not a direct match therebetween.

### BRIEF DESCRIPTION OF THE DRAWINGS

FIG. 1 is a block diagram of exemplary hardware on which the transportation route and/or warehouse space brokering software of the present invention is utilized;

FIG. 2 is a block diagram of the hardware components of and software modules stored in the central controller shown in FIG. 1;

FIGS. 3a-3f are exemplary Internet screens displayed by the software of the present invention for receiving and displaying an information profile of a transportation buyer (TB);

FIGS. 4a-4d are exemplary Internet screens displayed by the software of the present invention for receiving and displaying an information profile of a transportation provider (TP);

FIG. 5 is a map of the United States including various transportation routes or lanes displayed thereon;

FIG. 6 is a flowchart of the steps implemented by the software of the present invention for a TB;

FIG. 7 is a flowchart of the steps implemented by the software of the present for a TP;

FIG. 8 is a flowchart of the steps implemented in step 550 of FIG. 6;

FIG. 9 is a flowchart of the steps implemented in step 650 of FIG. 7;

FIGS. 10a and 10b are flowcharts of the steps implemented in step 570 of FIG. 6;

FIGS. 11a and 11b are flowcharts of the steps implemented in step 670 of FIG. 7;

FIG. 12 is an exemplary Internet screen displayed by the software of the present invention for receiving and displaying data regarding the transportation need of a TB; and

FIG. 13 is an exemplary Internet screen displayed by the software of the present invention for receiving and displaying data regarding the transportation capability of aTP.

### DETAILED DESCRIPTION OF THE PREFERRED EMBODIMENT

Essentially, the present invention is an Intemet-based transportation route and/or warehouse space auction software which receives transportation or warehouse space needs from transportation or warehouse space buyers and transportation route or warehouse space availability from transportation or warehouse space providers and which make such needs available for viewing on-line to buyers and providers, preferably simultaneously. The software enables buyers and providers to engage in bidding or auctioning on-line in order to determine a contract price for a transportation or warehouse space service. Preferably, the software enables the buyer and the provider to bind each other for performance of the service or space. This gives each party the assurance that the bid has been accepted and the service will be performed or the spaced leased for the accepted price.

The invention will now be described with reference to the transportation need of a transportation buyer (TB) and the transportation capability of a transportation provider (TP).

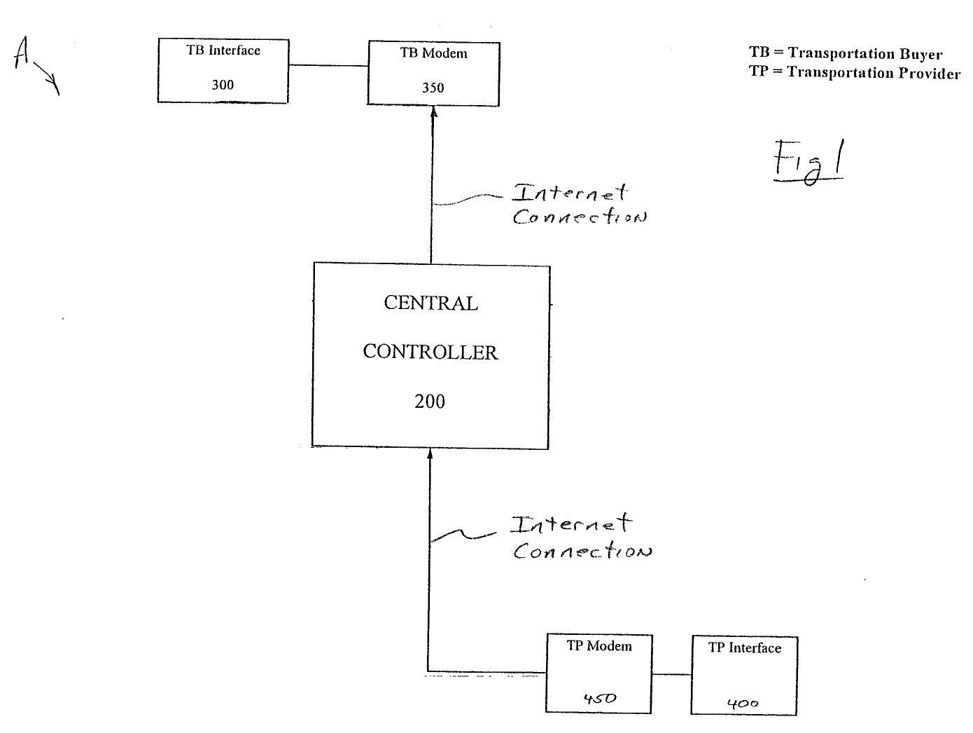

With reference to FIG. 1, an apparatus A for implementing the software includes a TB interface 300 and a TP interface 400 connected to central controller 200 via a TB modem 350 and a TP modem 450 and respective Internet connections, such as a public switched phone network. The Internet connections may also be provided by dedicated data lines, cellular communication link, personal communication systems, microwave or satellite networks. TB interface 300 and TP interface 400 are input and output gateways for communications with central controller 200.

Utilizing apparatus A, TBs and TPs can make their respective transportation needs and transportation capabilities known to each other; allow for on-line active bidding in order to satisfy each transportation need and transportation capability; and allow for TBs and TPs to legally bind each other for performance of the service.

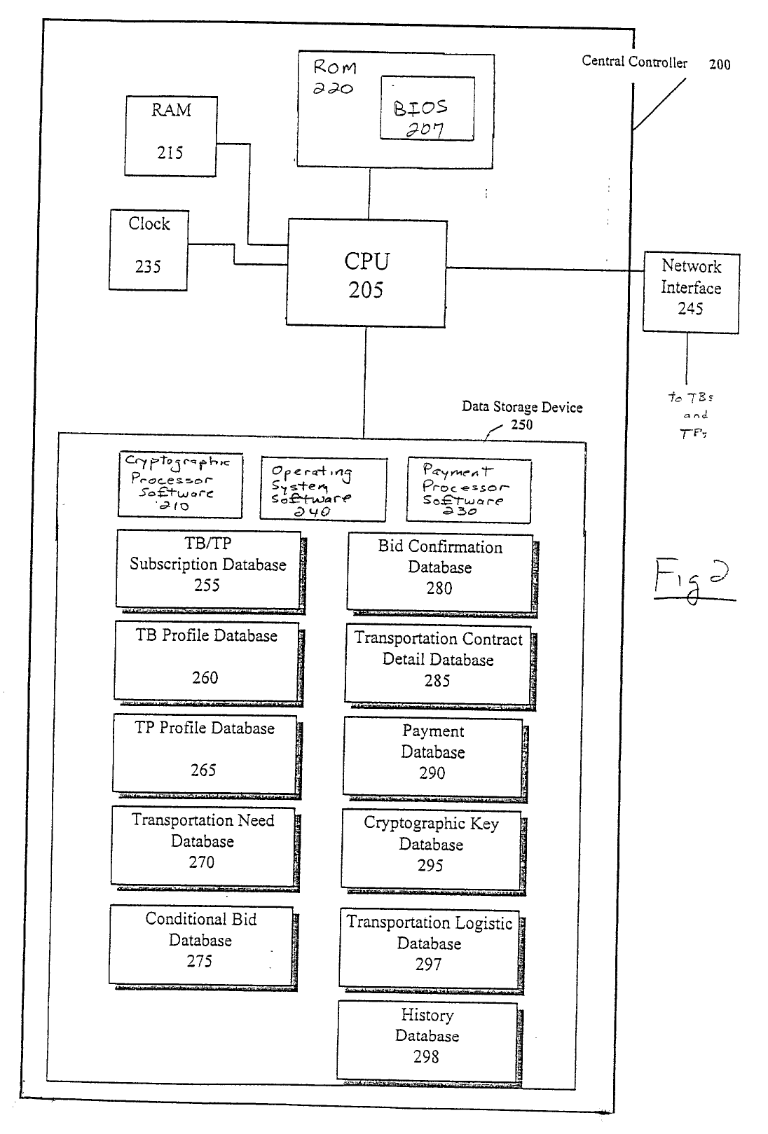

With reference to FIG. 2, and with continuing reference to FIG. 1, central controller 200 includes a central processor unit (CPU) 205, a random access memory (RAM) 215, a read-only memory (ROM) 220, a clock 235, a network interface 245 and a data storage device 250 which are interconnected in a manner known in the art to form a conventional computer.

A conventional personal computer or computer workstation with sufficient memory and processing capabilities may be used as central controller 200. Central controller 200 operates as an Internet web server, both receiving and transmitting transportation needs and capabilities between TPs and TBs. Central controller 200 must be capable of high volume transaction processing, performing a significant number of mathematical calculations, processing communications, displaying graphics and searching databases.

Data storage device 250 may include a hard disk magnetic or optical storage unit, such as a CD ROM drive, or a flash memory. Data storage device 250 includes cryptographic processor software 210, payment processor software 230, and operating system software 240, as well as databases used in the processing of transactions. Operating system software 240 (hereinafter “software 240”) is utilized by CPU 205 to implement the present invention on central controller 200. CPU 205 utilizes cryptographic processor software 210 to authenticate communications from TPs, TBs, and other potential parties, e.g., credit card companies, banks and credit bureaus, as well as anonymous transactions. CPU 205 utilizes payment processor software 230 to support electronic funds transfer and/or exchange of payments, charges, debits and/or credits. The databases included in data storage device 250 includes a TB/TP subscription database 255, a TB profile database 260, a TP profile database 265, a transportation need database 270, a conditional bid database 275, a bid confirmation database 280, a transportation contract detail database 285, a payment database 290, a cryptographic key database 295, a transportation logistics database 297 and a history database 298. Preferably, commercially available database software is utilized to create and manage these databases.

TB/TP subscription database 255 retains basic data on TBs and TPs, such as name, address, credit card and other billing information, phone numbers, employer identification number, social security number, E-mail address, past system usage, length of subscription, security information and other relevant data. This information is obtained when each TB and each TP first registers via software 240.

TB profile database 260 retains relevant information about each TB. This information includes name, address, internal personnel contacts, shipping and receiving loading dock information, hours of dock operation, shipment status requirements, accounting information and other relevant information.

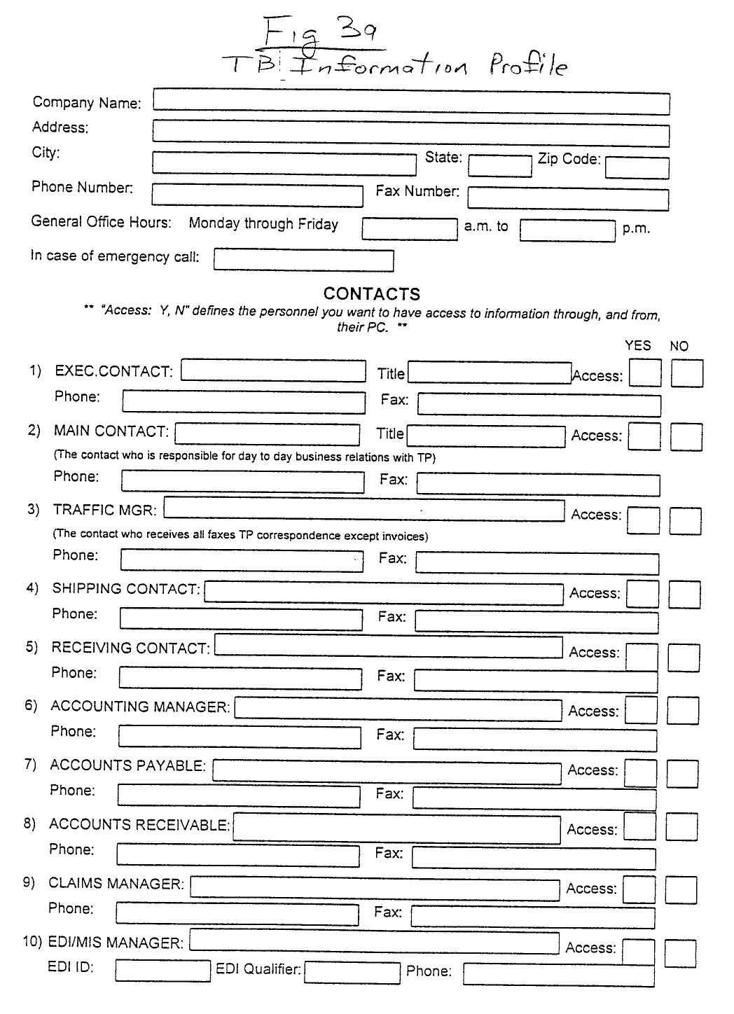

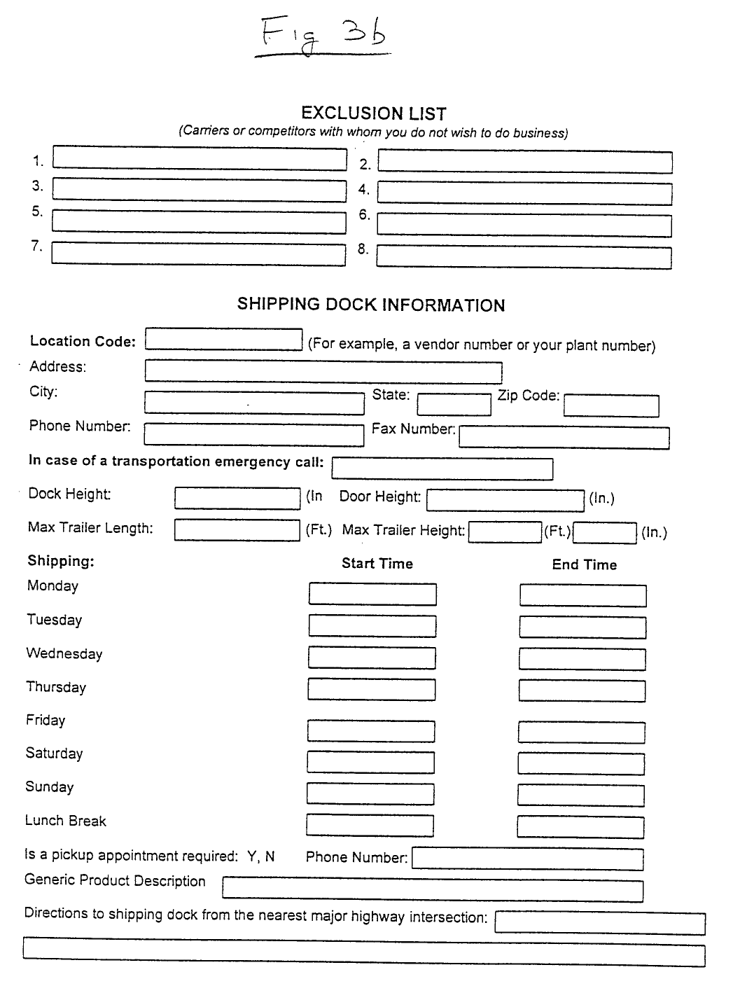

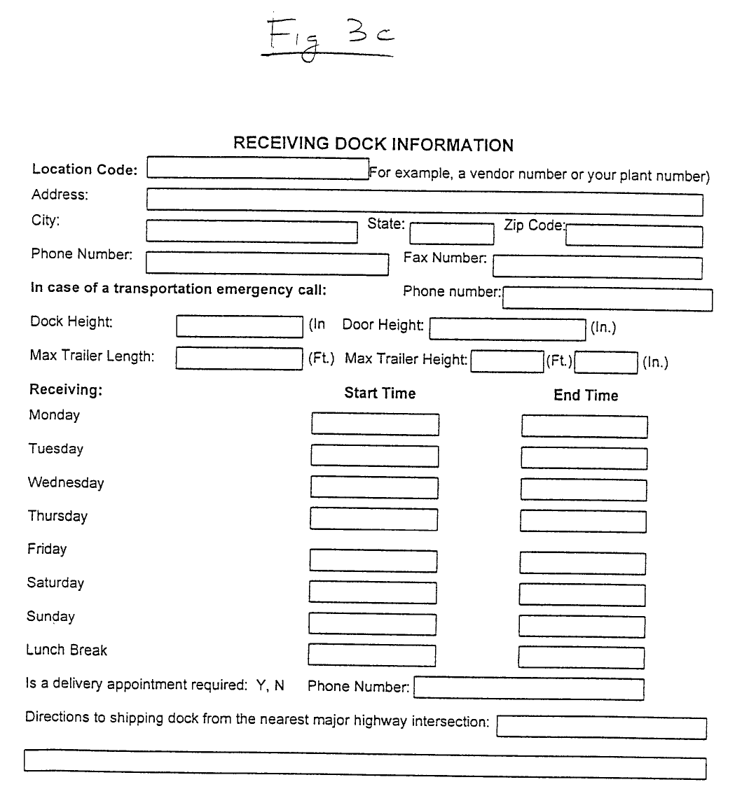

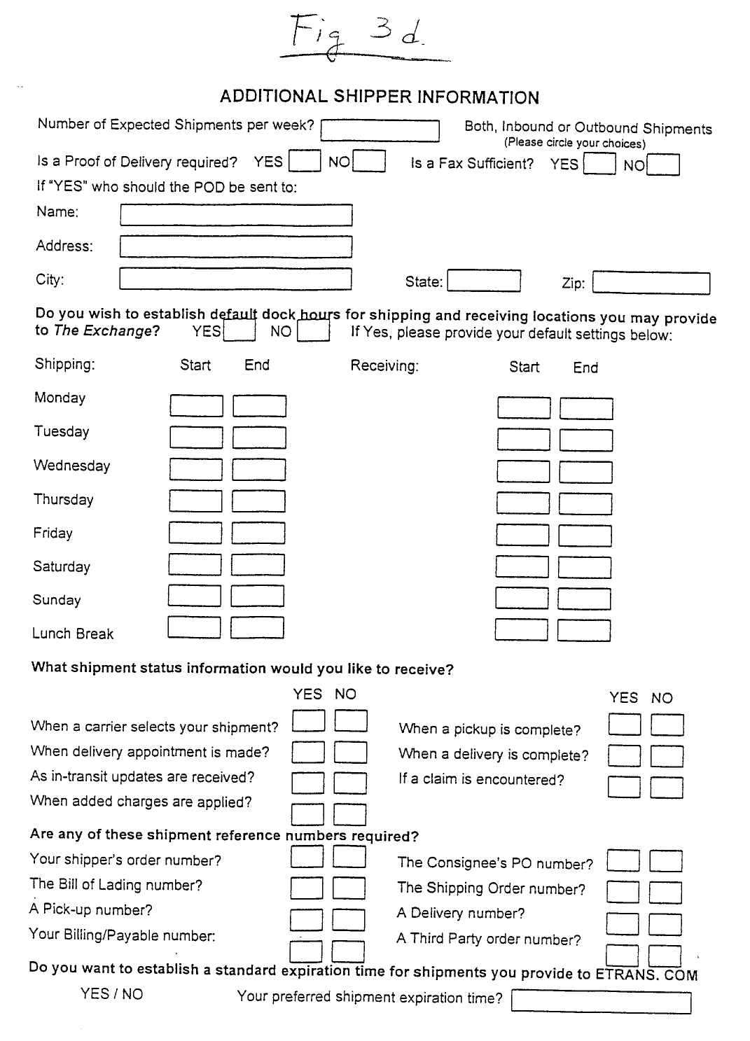

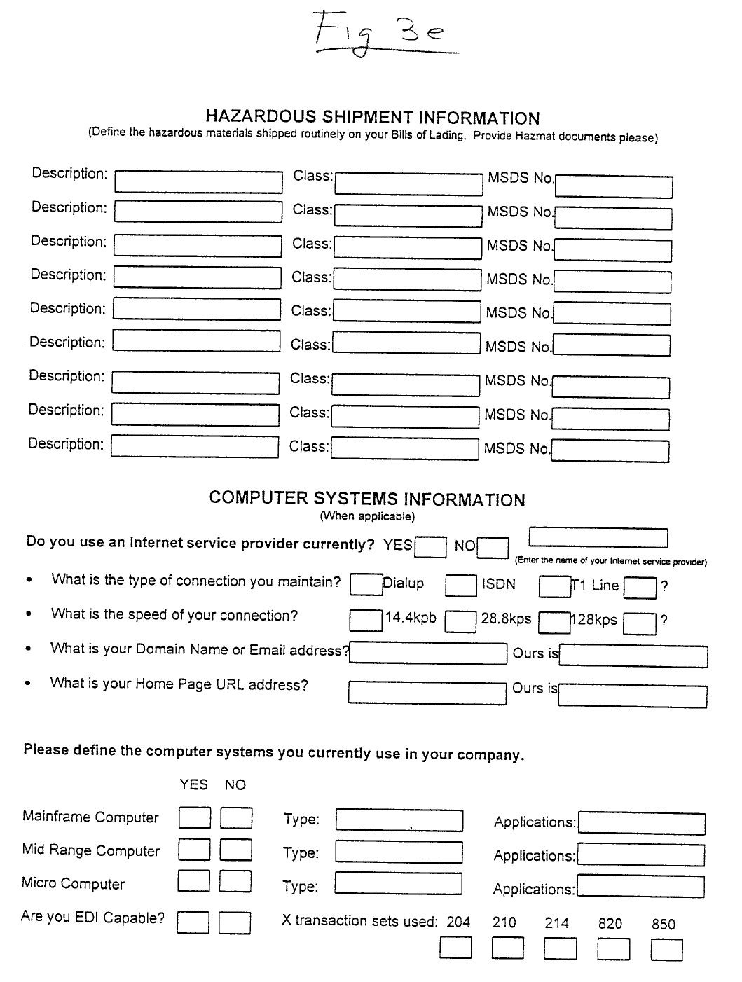

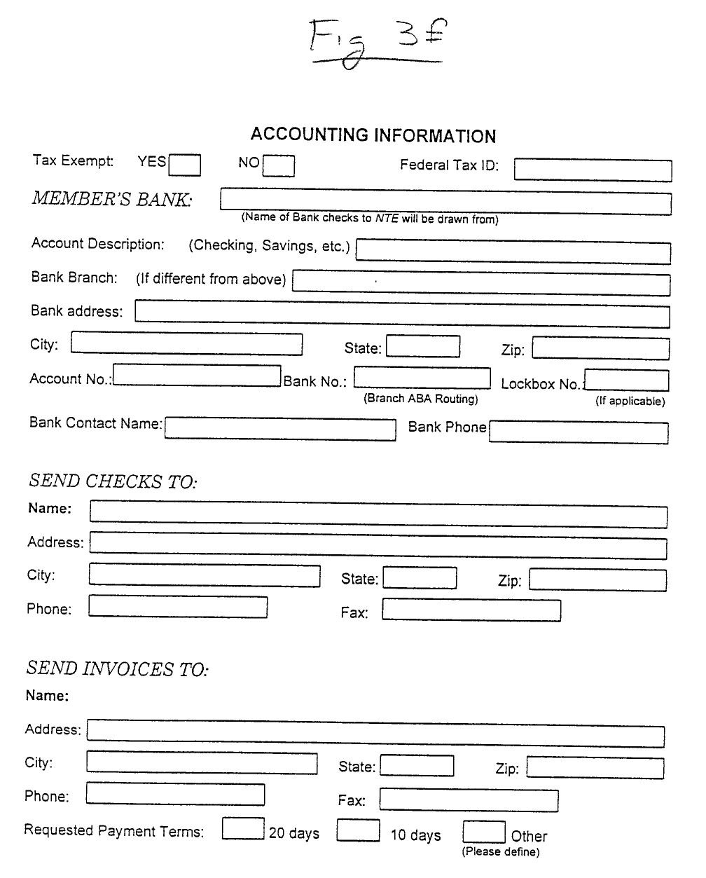

With reference to FIGS. 3a-3f, one or more Internet accessible TB information profile data screens can be accessed by a TP at TP interface 400 prior to accepting a bid from a TB or prior to bidding on a TB's need. The data displayed in the various fields of the one or more TB information profile data screens of FIGS. 3a-3f are received from a TB during the TB's registration process.

With reference back to FIG. 2, TP profile database 265 retains relevant information about the TP. This information includes name, address, internal personnel contacts, financial information, available number of drivers and relevant experience, location of terminals, size of truck fleet, safety information, tracking information, hours of operation, states of operation and other relevant information.

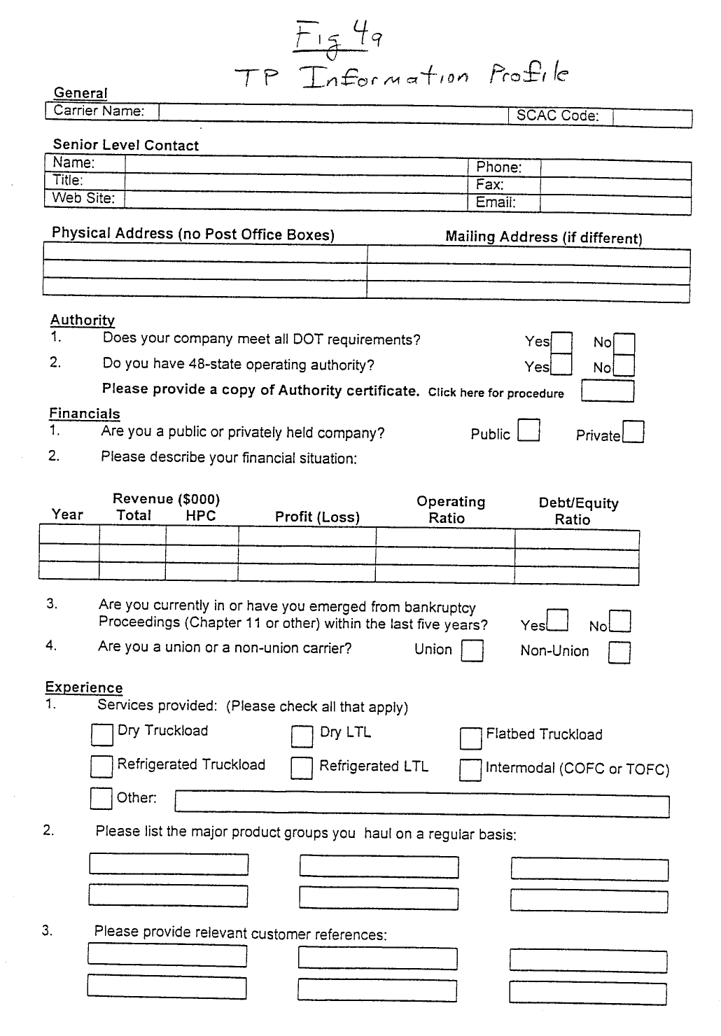

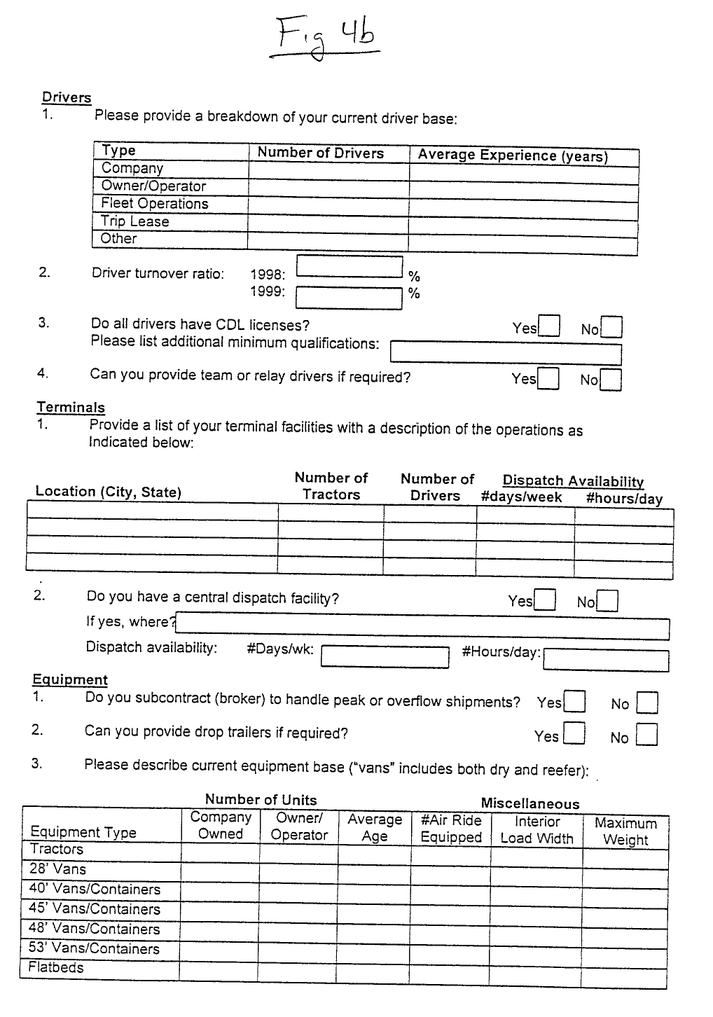

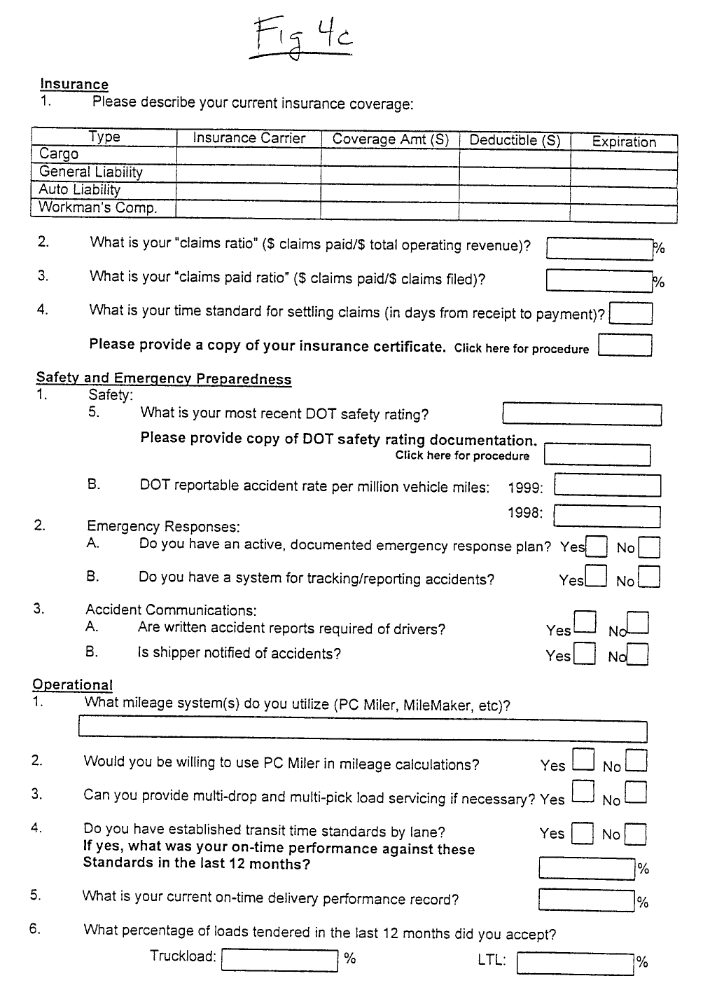

With reference to FIGS. 4a-4d, one or more Internet accessible TP information profile data screens can be accessed by the TB at TB interface 300 prior to accepting a bid from a TP or prior to bidding on a TP's capability. The data displayed in the various fields of the one or more TP information profile data screens of FIGS. 4a-4d are received from a TP during the TP's registration process.

To avoid entry of data in TB/TP subscription database 255 that is common with data in TB profile database 260 and/or TB profile database 265, such data can be related utilizing relational database techniques known in the art.

With reference back to FIG. 2, transportation need database 270 retains information about each transportation need of a TB and each transportation capability of a TP. Preferably, the transportation needs are broken into different categories, such as long-term, mid-term and short-term, needs. For a TB, each need would contain origins and destinations of shipments, description of shipments, weight information, timetables related to pick up and delivery, maximum payment information, expiration of need and other relevant information. For a TP, each capacity would contain current location and destination, capacity, type of truck or vehicle, load description information, time tables related to pick up and delivery, minimum payment information, expiration of need and other relevant information. Transportation need database 270 can also include information related to available warehouse space capabilities and warehouse space needs.

Conditional bid database 275 tracks all bid information related to a transportation need or a transportation capability until the need or capability is fulfilled or expires. For each transportation need or capability, conditional bid database 275 includes fields, such as status, bid tracking number, date, time, bid price, expiration date, payment terms, TB and TP identification and other relevant information.

Bid confirmation database 280 tracks messages sent between the TP and the TB confirming that a bid has been accepted. Fields include the names and ID numbers of the TB and the TP, a bid acceptance confirmation number, an associated conditional bid ID and other relevant information.

Transportation contract detail database 285 includes boilerplate contract clauses that are included in the contract that accompanies the confirmation of a bid acceptance. The clauses contained in this database combined with the data from the transportation need database 270 and bid confirmation database 280 can be used to automatically generate a contract that effectively binds the TP and TB to satisfy the transportation need and/or capability.

Payment database 290 tracks all payments that are made in connection with an accepted bid. This database includes the TB and TP names, ID numbers of the TB and the TP, the amount of each payment, method of payment, the associated bid acceptance confirmation number and other relevant information.

Cryptographic key database 295 facilitates cryptographic functions, storing both symmetric and asymmetric keys. These keys are used by cryptographic processor software 210 for encrypting and decrypting bids, bid confirmation, TP and TB profiles, payment information and other relevant information.

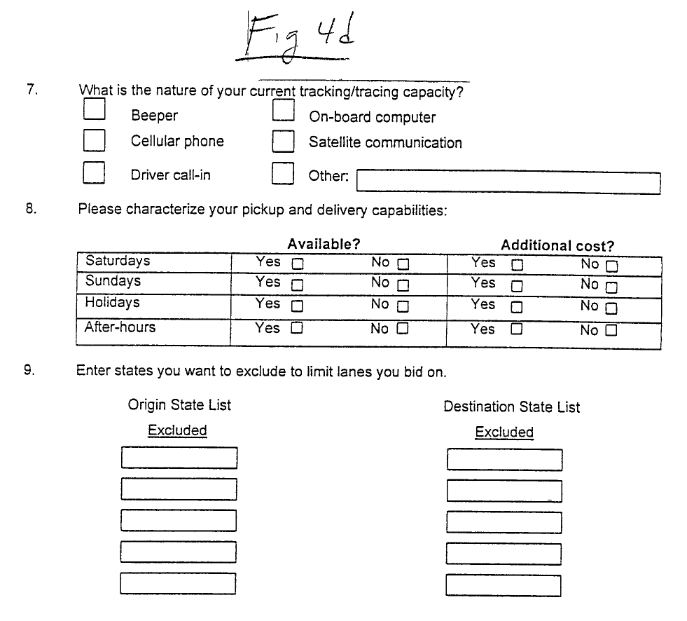

Transportation logistics database 297 includes transportation mapping information. This database can include for each transportation need and/or capability a map such as the maps shown in FIG. 5, as detailed direction information between the origin and the destination of each transportation need or capability. Preferably, the map and/or detailed direction information for each transportation need or capability are generated automatically by software 240 from the data received in transportation need database 270.

History database 298 stores transaction information relating to the posting of bid confirmation acceptance. More specifically, this database retains a transaction history of all bid confirmations received by the bid confirmation database 280.

With ongoing reference to FIG. 2, network interface 245 is the gateway to communicate with a TB and a TP via the Internet through respective TB interface 300 and TP interface 400. Conventional internal or external modems may serve as network interface 245. Preferably, network interface 245 is connected with the Internet and/or any of the commercial on-line services.

TB interface 300 and TP interface 400 are typically conventional personal computers having input devices, such as a mouse, keyboard, video monitor, a processing device such as a CPU, a storage device such as a hard disk drive and a network interface such as a modem. There are many commercially available software applications that can enable the communications required by the TB interface 300 and TP interface 400. The primary function of the interface is for message creation and transmission. When the central controller 200 is configured as a web server, conventional communication software such as the Netscape Navigator web browser from Netscape Corporation may also be used. The TP and TB may communicate all information through the Netscape Navigator browser. No proprietary software is required.

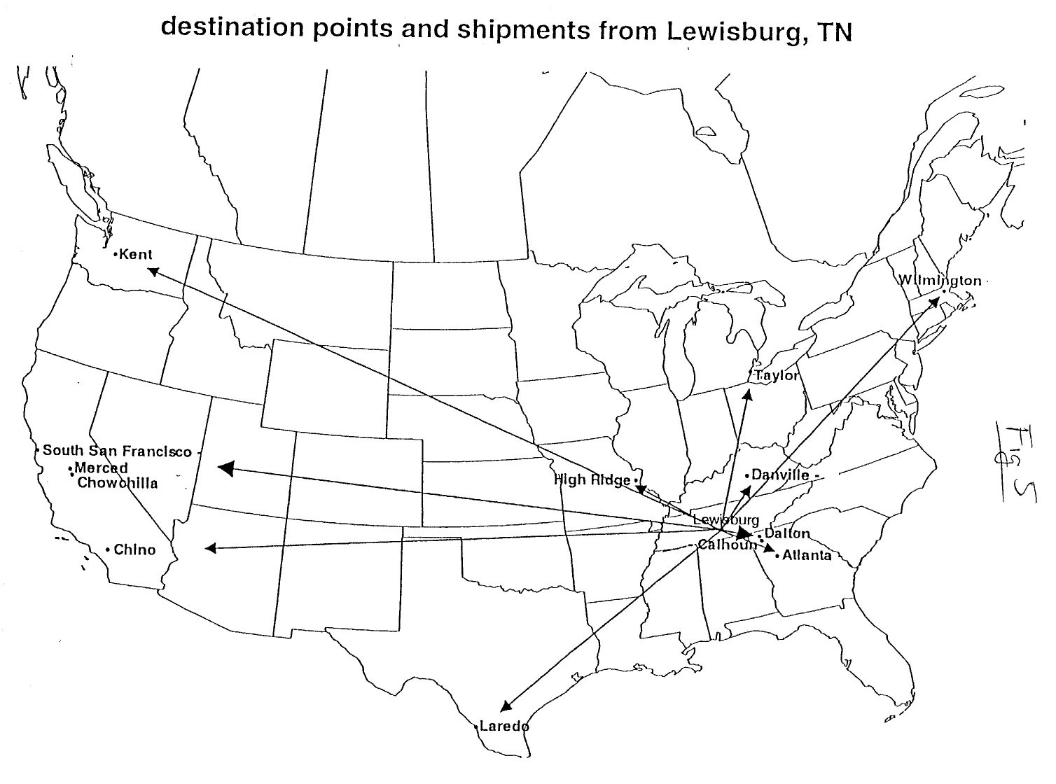

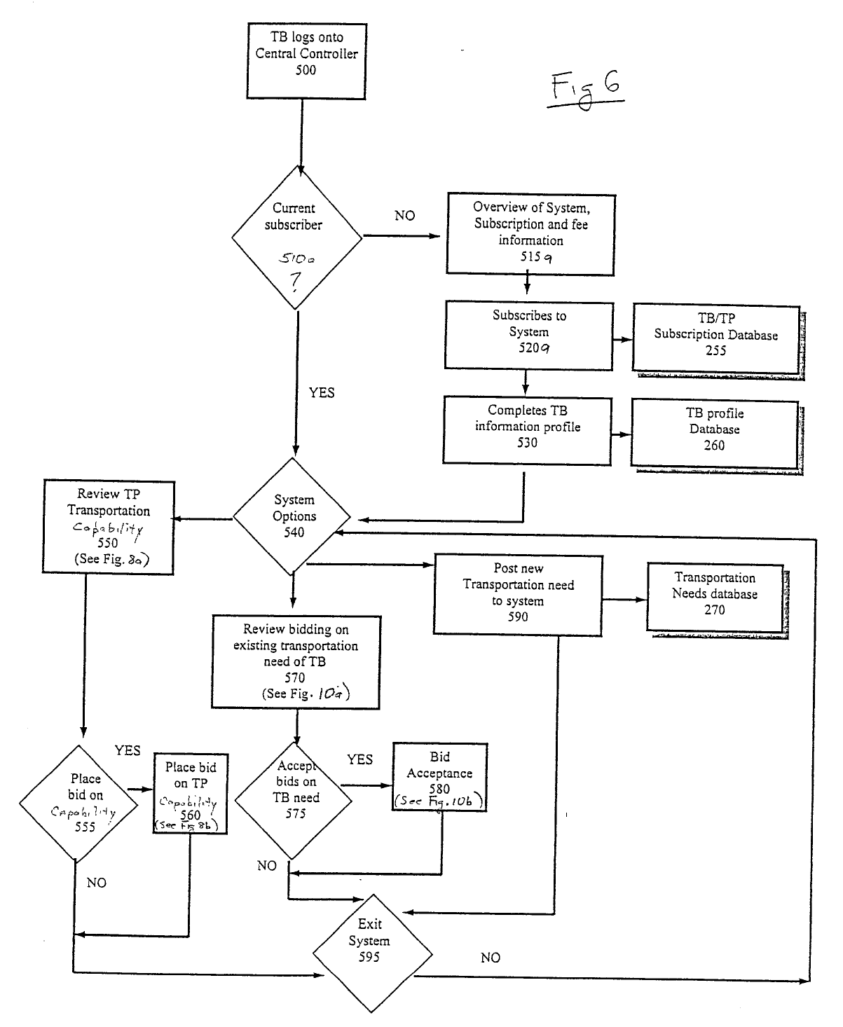

With reference to FIG. 6, in operation, software 240 executes a step 500 where a TB logs into the central controller 200 from TB interface 300 via TB modem 350 and network interface 245, thereby establishing a communications link. With reference to FIG. 7, software 240 executes a step 600 where a TP logs onto central controller 200 from TB interface 400 via TB modem 450 and network interface 245, thereby establishing a communications link.

Preferably, central controller 200 is an Internet web server which hosts an Internet a web page that enables each TB and each TP to interface with central controller 200 operating in accordance with software 240. After log in at this web page, each TB or TP is prompted in step 510a or 510b, respectively, whether they are a current subscriber. If not, in step 515a or 515b, the respective TB or TP can access information screens that provide an overview of how the system operates as well as pricing and subscription information.

If the TB or the TP chooses to subscribe, in steps 520a or 520b, the respective TB or TP completes an on-line subscription application (not shown). This subscription data, which includes the name, address, credit card and other billing information, phone numbers, employer identification number, social security number, E-mail address, past system usage, length of subscription, security information and other relevant data of each TB/TP, is stored in TB/TP subscription database 255. Software 240 assigns a unique identification number and password to each subscriber. The password may be changed at the subscriber's option.

Once the subscription process is complete, the TB and TP will be prompted to complete a TB information profile 530 or a TP information profile 630, respectively. The one or more screens for receiving TB information profile data are shown in FIGS. 3a-3f, and the one or more screens for receiving TP information profile data are shown in FIGS. 4a-4d. This information received from a TB and/or a TP will be stored in the respective TB profile database 260 and TP profile database 265. Other supplemental documentation may also be required as part of the TP profile.

The TP will be required to submit copies of operating authority certificates, copies of insurance certificates and Department of Transportation (DOT) safety rating documentation. These certificates can be scanned into TP interface 400 (using commercially available scanning hardware and software) and electronically transmitted to the central controller 200 via TP modem 450. If the TP does not have the equipment to scan the certificates, copies of the certificates can be mailed or faxed to the entity operating the web site for entry into TP profile database 265 for the TP. The software 240 will also notify a TP via the Internet if any certificates are about to expire. A TP will not be permitted to bid on a transportation need of a TB if any of its certificates are expired. The data received in TB profile database 260 and TP profile database 265 will enable the TB and TP to fully evaluate whether they want to conduct business with each other. Software 240 will also permit the TB and TP to link to each other's web site to acquire additional information.

In order to maintain confidentiality, the TB and TP will have the option to enter the term “confidential” in many of the profile data input fields shown in FIGS. 3a-3f and 4a-4d, respectively. However, certain data input fields containing the word “confidential”, may limit the transportation need or capability that the TB or TP can bid.

With continuing reference to FIGS. 6 and 7, in steps 540 and 640, the respective TB and TP can select three broad options. If a TB is logged into the software 240, in step 540, the TB can choose to (i) review, in step 550, the transportation capability of a TP; (ii) review, in step 570, bidding on existing transportation need of the TB; or (iii) post, in step 590, one or more new transportation needs to central controller 200. If a TP is logged into software 240, in step 640, the TP can choose to (i) review, in step 650, the transportation need of a TB; (ii) review, in step 670, bidding on existing transportation capability of the TP; or (iii) post, in step 690, one or more new transportation to controller 200.

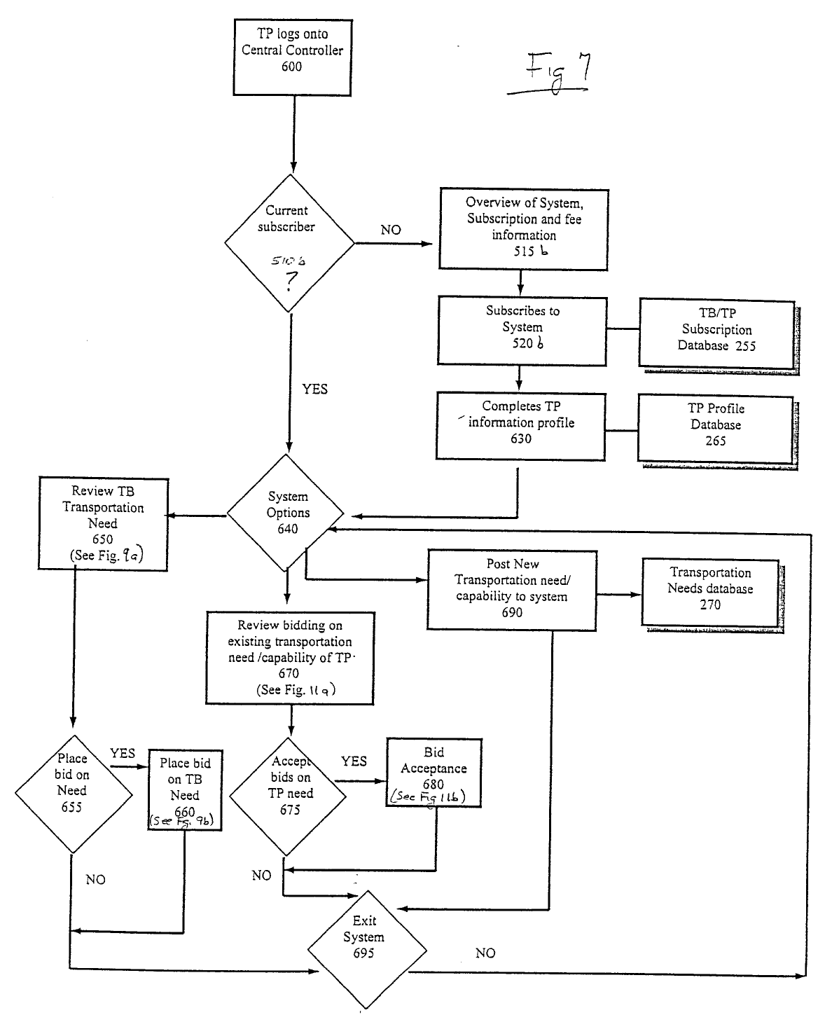

With reference to FIG. 8, and with continuing reference to FIG. 6, if the TB is logged in and has selected, in step 550, to review the transportation capability of a TP, software 240 branches to the steps shown in FIG. 8. This permits the TB to review the transportation capability of a TP and place a bid on that capability. For example, if a TP has an empty truck located in Chicago. Ill. which will be going to Pittsburgh, PA on December 2, the TB may have a product that also needs moved from Chicago, Ill. to Pittsburgh, Pa. In step 550.10, the TB enters parameters of his transportation need prior to viewing the transportation capabilities of a TP. Specifically, the TB would enter the transportation need data related to the origin and destination of its product, the product weight, description, type of truck needed, e.g., refrigerated, and other relevant data. Based on the entered data, the central controller 200, in step 650.20, will extract data from the transportation need database 270 regarding transportation capabilities of TPs that fulfill the transportation need of the TB based on the entered data. This process prevents the TB from viewing the transportation capabilities of TPs that are irrelevant to TB's transportation needs or preferences.

Software 240 can include one or more predetermined rules which are utilized in making a determination whether or not the transportation capability of a TP fulfills the transportation need of a TB when there is not a direct match therebetween. For example, assume that a TP has an empty truck moving from Pittsburgh, Pa. to Chicago, Ill. via Cleveland, Ohio. Further, assume that a TB has freight that needs moved from Columbus, Ohio to Chicago, Ill. Software 240 can include a rule whereby a transportation need within a predetermined number of miles, e.g., 200 miles, of a transportation route will be fulfilled by the transportation capability, or a transportation capability within a predetermined number of miles of a transportation need will fulfill the transportation need. One or more additional rules can be included in software 240 so that more records that will be fulfilled by the transportation capabilities and/or the transportation needs can be retrieved. These rules can be permanently programmed into software 240 or can be modified by a TB or a TP via a field of an Internet screen (not shown).

In step 550.40, the TB reviews the transportation capabilities of each TP for potential bid. In addition, the TB will be able to review (i) existing bids on the TP's capability from other TBs; (ii) information about the TP; and (iii) logistical information. This information will be extracted from the TP profile database 265, conditional bid database 275 and transportation logistic database 297, respectively. This step will enable the TB to determine if the bid price is within range, and if the TP to qualified to move the TB's products.

Steps 550.42 and 550.44 provide the TB the ability to download data regarding the TPs transportation capabilities as well as any existing bid information from the central controller 200 through the TB interface 300 into the TB's own transportation analysis software for further analysis. This feature is especially useful for enabling the TB to evaluate bids for numerous lanes or long-term contracts. In step 555, the TB determines if he wants to place a bid on the TP's transportation capabilities. If so, the operating system software 240 branches to step 560 where the TB submits his bid and the bid data is sent to conditional bid database 275.

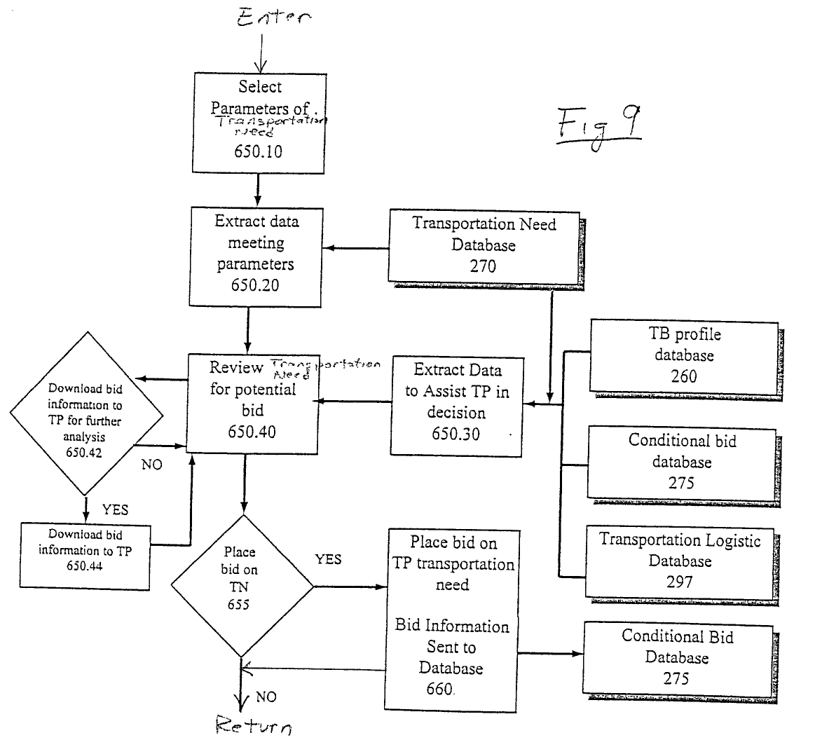

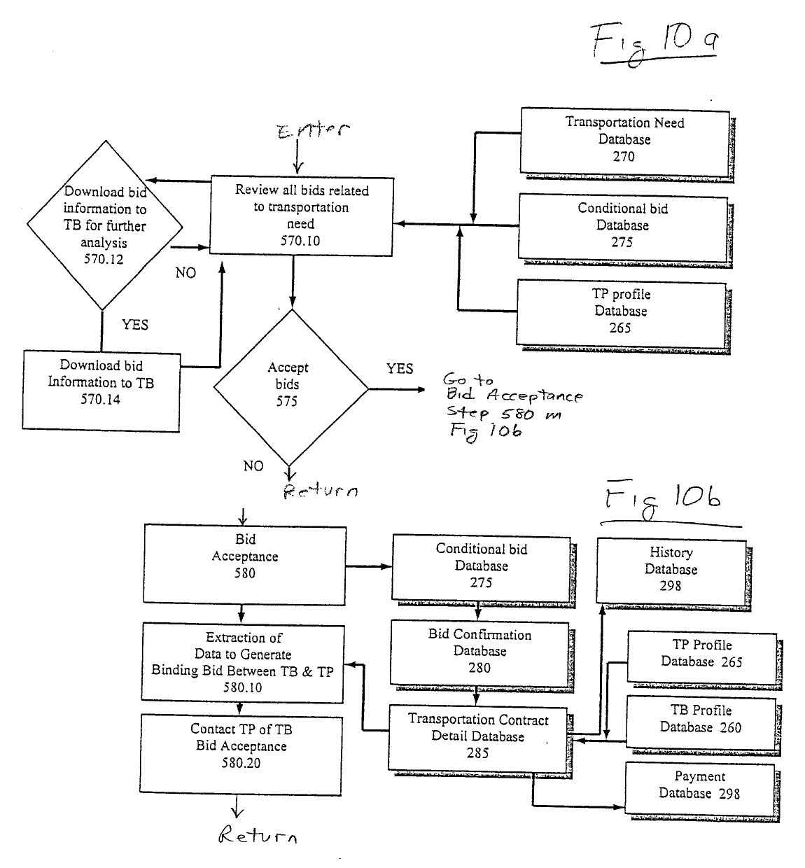

With reference to FIGS. 10a and 10b, and with continuing reference to FIG. 6, if the TB has logged in and has selected, in step 570, to review bidding on its own transportation needs, the software 240 branches to the steps shown in FIG. 10a. From information contained in transportation need database 270, conditional bid database 275 and TB profile database 265, the TB will be able to review a TP's bid related to the TB's transportation need. The bids shown will only be from those TPs that have met preset parameters of the transportation need. The TB will also be able to review the TP profile information associated with each bid.

Steps 570.12 and 570.14 provide the TB the ability to download bid information associated with its own transportation needs from the central controller 200 through the TB interface 300 for further analysis. This ability is especially useful for evaluating bids for numerous lanes or long-term contracts. TB's transportation analysis software often has the capability to determine the best combination of TPs to fulfill the TB's various transportation needs. In step 575, the TB determines if he wants to accept the bid placed on its transportation need. If so, the software 240 branches to step 580 where the TB accepts the TP's bid using the steps shown in FIG. 10b.

As shown in FIG. 10b, the data associated with the bid is transferred from the conditional bid database 275 to the bid confirmation database 280 and transportation contract detail database 285. In step 580.10, data is extracted from TP profile database 265, TB profile database 260 and transportation contract detail database 285 to form a legally binding bid acceptance contract. The data related to the bid acceptance contract is copied from the transportation contract detail database 285 to history database 298. In step 580.20, the software 240 contacts the TP via the Internet and advises the TP of the TB's bid acceptance. The TP and TB will receive an electronic copy of the binding contract. Alternatively, the TB notifies the TP via telephone, facsimile, letter, etc. of the bid acceptance. Further interaction between the TP and the TB, not discussed herein, will likely occur to establish payment terms and other procedures associated with the transportation need. The relevant contact information is provided from data in the TP and TB profile databases 260 and 265.

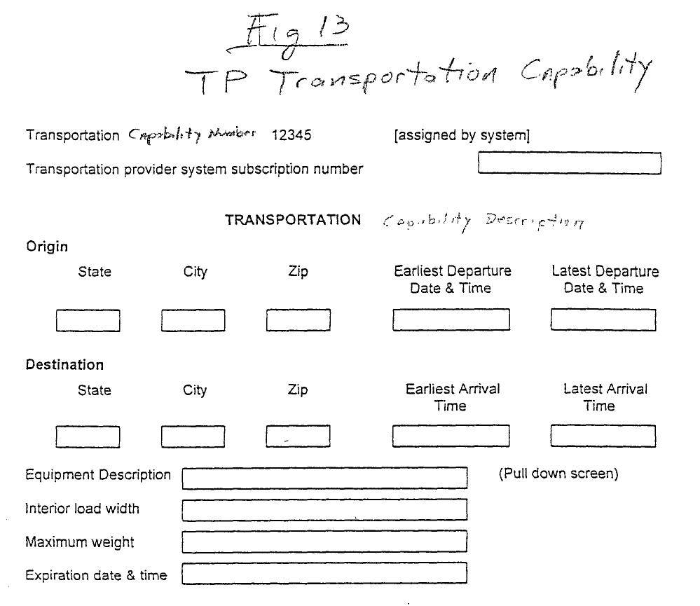

In FIG. 6, step 590 is provided to enable the TB to post a new transportation need. If the TB decides to execute step 590, software 240 displays on the TB's display terminal, the TB transportation need screen shown in FIG. 12. As shown in FIG. 12, the transportation need is assigned a unique transportation need number. This number is used to track the transportation need. The TB will enter the expiration date of the transportation need and software 240 will automatically notify the TB of expired transportation needs for possible removal.

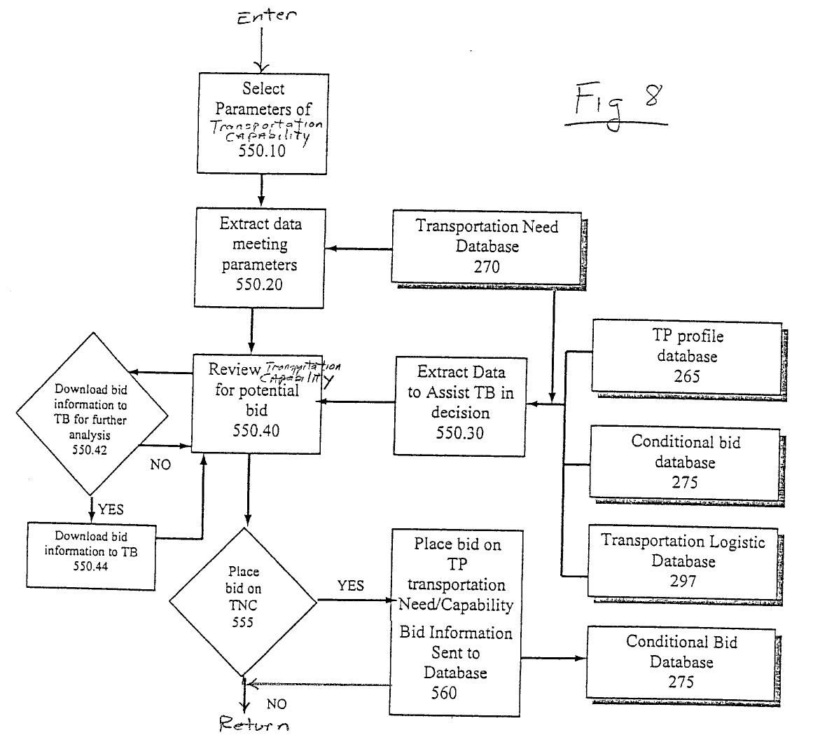

With reference to FIG. 9, if the TP has logged in and has selected, in step 650, to review the transportation need of a TB, software 240 branches to the steps shown in FIG. 9. This permits a TP to review the transportation need of a TB and place a bid on that need. For example, if a TB has products that need moved from Cleveland, Ohio to Pittsburgh, Pa. during a specific period, e.g., January 1 through June 15, in step 650.10, the TP enters parameters of his transportation capability prior to viewing the needs of TBs in the transportation need database 270. Specifically, the TP would enter transportation capability data related to the location of operations, available equipment, weight capacities, minimum bid and other relevant data. Based on the entered data, central controller 200 will, in step 650.20, extract from the transportation need database 270 the TB's transportation needs that are fulfilled by the transportation capability of the TP based on the entered data. This process prevents the TP from viewing the transportation needs of TBs that are outside the scope of the TP's transportation capabilities or preferences.

In step 650.40, the TP reviews the transportation needs of each TB for potential bids. In addition, the TP will be able to review (i) existing bids on the transportation need from other TPs; (ii) information about the TB; and (iii) logistical information. This information will be extracted from the TB profile database 260, conditional bid database 275 and transportation logistic database 297, respectively. This step enables the TP to determine if the bid price is acceptable, and whether the TB is a company for which the TP wants to provide transportation services.

Steps 650.42 and 650.44 provide the TP the ability to download data regarding the TB's transportation needs and related bid information from central controller 200 through the TP interface 400 and network interface 245 into the TP's own transportation analysis software for further analysis. This is especially useful for enabling the TP to evaluate bids for numerous lanes or long-term contracts. In step 655, the TP determines if he wants to place a bid on TB's transportation need. If so, the software 240 branches to step 660 where the TP submits his bid and the bid data is sent to the conditional bid database 275.

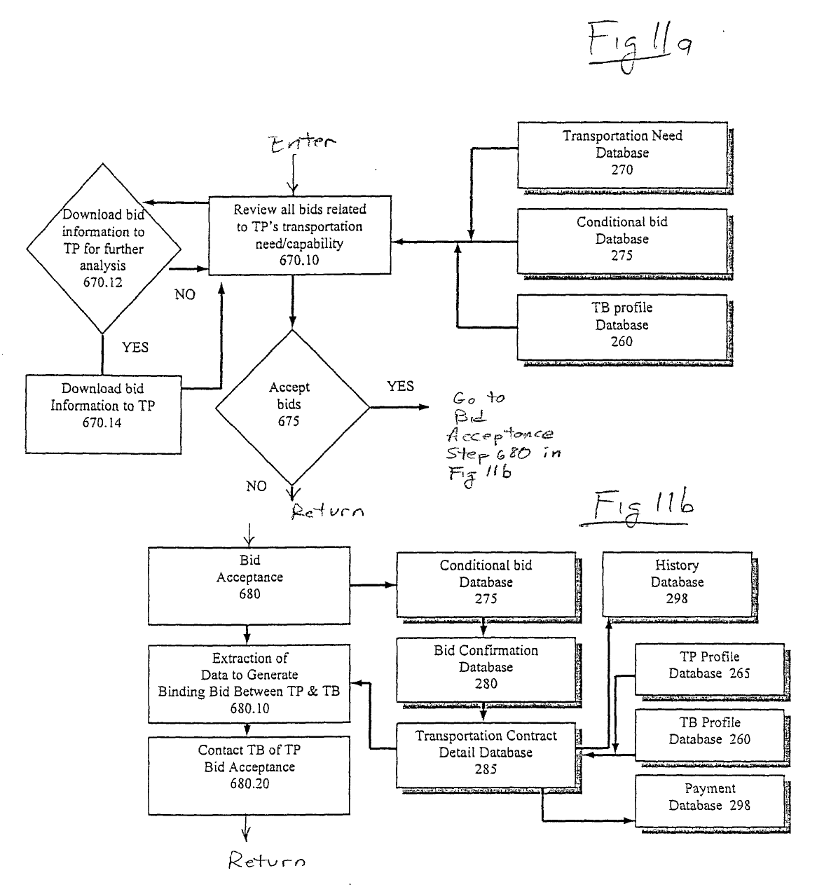

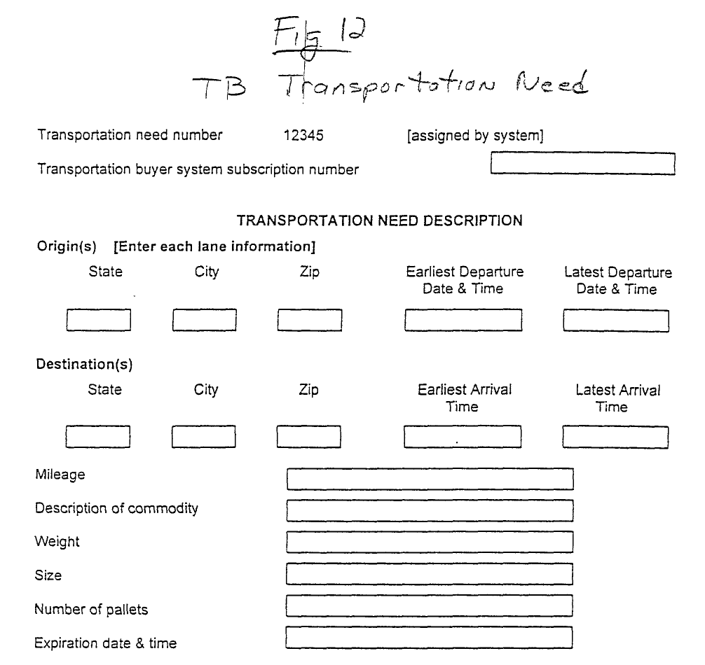

With reference to FIG. 11a and 11b, and with continuing reference to FIG. 7, if the TP is logged in and has selected, in step 670, to review bidding on its own transportation capabilities, software 240 branches to the steps shown in FIG. 11a. From information contained in transportation need database 270, conditional bid database 275 and TB profile database 260, the TP will be able to review TBs' bids related to its transportation capability. The bids shown will only be from those TBs that have met the preset parameters of TP's transportation capabilities. The TP will be able to review the TB profile information associated with each bid to determine if the TB is a company with which the TP wishes to conduct business.

Steps 670.12 and 670.14 provide the TP the ability to download data regarding the TB's transportation needs, as well as any existing bid information for the TB's needs from central controller 200 through TP interface 400 and network interface 245 into the TP's transportation analysis software for further analysis. This especially useful for enabling the TP to evaluate bids for numerous lanes or long-term contracts. In step 675, the TP determines if he wants to accept the TB's bid placed on the TP's transportation capability. If so, software 240 branches to step 680 where the TP accepts the bid.

As shown in FIG. 11b, the data associated with the bid is transferred from the conditional bid database 275 to bid confirmation database 280 and transportation contract detail database 285. In step 680.10, data is extracted from TP profile database 265, TB profile database 260 and transportation contract detail database 285 to form a legally binding bid acceptance contract. The data related to the bid acceptance contract is copied from transportation contract detail database 285 to history database 298. In step 680.20, the software 240 contacts the TB via the Internet and advises the TB of the TP's bid acceptance. The TP and TB will receive an electronic copy of the binding contract. Alternatively, the TP notifies the TB via telephone, facsimile, letter, etc. of the bid acceptance. Further interaction between the TP and TB, not discussed herein, will likely occur to establish payment terms and other procedures associated with the transportation need. The relevant contact information is provided from data in the TP and TB profile databases 260 and 265.

With reference back to FIG. 7, step 690 is provided to enable the TP to post a new transportation capability. If the TP decides to execute step 690, software 240 displays on the display terminal of the TP, the TP's transportation capability screen, shown in FIG. 13. As shown in FIG. 13, the transportation capability is assigned a unique transportation capability number. This number is used to track the transportation capability. The TP will enter the expiration date of the transportation capability and software 240 will automatically notify the TP of expired transportation capabilities for possible removal.

While described above in connection with transportation needs of a TB and the transportation capabilities of a TP, software 240 can also be utilized for auctioning of available warehouse space of a warehouse space provider (WSP) and warehouse space need of a warehouse space buyer (WSB). Specifically, central controller 200 can receive from a computer of a WSP an available warehouse space capability of the WSP. Central controller 200 can also receive from a computer of a WSB a warehouse space need of the WSB. Central controller 200 can compare the warehouse space capability of the WSP to the warehouse space need of the WSB to determine if the warehouse space capability fulfills the warehouse space need. The warehouse space capability can include the location of the warehouse space, the volume of warehouse space available, and the cost per unit volume of the available warehouse space. The warehouse need can include the desired location of the warehouse space, the volume of warehouse space needed, and the desired cost per unit volume of the warehouse space.

If central controller 200 determines that an available warehouse space capability fulfills the warehouse space need, central controller 200 transmits to the WSB information regarding the warehouse space capability of the WSP. The WSB can review this information to determine if a bid should be placed thereon. If so, the WSB transmits from his computer to central controller 200 a bid for the warehouse space capability of the WSP. Central controller 200 forwards the bid to the computer of the WSP for review by the WSP. The WSP can review the bid to determine if he will accept the bid. If the WSP decides to accept the bid, he transmits from his computer to central controller 200 a bid acceptance.

When central controller 200 receives the bid acceptance from the WSP, central controller 200 transmits a confirmation of the bid acceptance to the WSB. In addition, central controller 200 prepares from data stored thereat a bid acceptance contract. This data can include boilerplate contract provisions extracted from transportation contract detail database 285, as well as the names of the WSB and the WSP. Central controller 200 then transmits the bid acceptance contract to the computers of the WSB and the WSP.

Software 240 can include at least one predetermined rule which is utilized to determine if the warehouse space capability of the WSP fulfills the warehouse space need of the WSB when there is not a direct match therebetween. For example, if a warehouse space need is ten miles from a warehouse space capability, or vice versa, software 240 can use the predetermined rule to match the need with the capability absent an exact match therebetween.

In addition, if a WSP is seeking to fill available warehouse space capability, software 240 can be configured so that central controller 200 transmits to the computer of the WSP the warehouse space need of each WSB that can be fulfilled by the warehouse space capability of the WSP. The WSP can review the warehouse space need of the WSB to determine if a bid should be placed thereon. If so, the WSP transmits a bid for the warehouse space need of the WSB to central controller 200. Central controller 200 forwards the bid to the computer of the WSB for review and acceptance. If the WSB decides to accept the bid, the WSB transmits a bid acceptance from his computer to central controller 200.

In the manner discussed above, central controller 200 can transmit to the computer of the WSP a confirmation of the bid acceptance, as well as prepare and transmit a bid acceptance contract to the computers of the WSB and the WSP.

One or more rules can be utilized by software 240 for determining when a warehouse space need is fulfilled by a warehouse space capability.

In connection with warehouse space needs of a WSB and warehouse space capabilities of a WSP, the databases stored in data storage device 250 in FIG. 2 can be utilized in the same manner as described above in connection with transportation needs of a TB and the transportation capabilities of a TP.

The invention has been described with reference to the preferred embodiment. Obvious modifications and alterations will occur to others upon reading and understanding the preceding detailed description. For example, while described in connection with transportation needs and capabilities over land, the present invention can also be used to fulfill transportation needs and capabilities via sea, air or rail. It is intended that the invention be construed as including all such modifications and alterations insofar as they come within the scope of the appended claims or the equivalents thereof.

I claim:

1. A method of brokering freight transportation routes, the method comprising the steps of:
(a) receiving at a server computer from a computer of a transportation provider (TP) an available transportation capability of the TP;
(b) receiving at the server computer from a computer of a transportation buyer (TB) a transportation need of the TB;
(c) comparing at the server computer the available transportation capability of the TP and the transportation need of the TB;
(d) determining if the available transportation capability of the TP fulfills the transportation need of the TB;
(e) if the available transportation capability of the TP fulfills the transportation need of the TB, transmitting from the server computer to the computer of the TB the available transportation capability of the TP;
(f) in response to receiving the available transportation capability of the TP, transmitting from the computer of the TB to the server computer a bid by the TB for the available transportation capability of the TP;
(g) forwarding the bid from the server computer to the computer of the TP; and
(h) in response to receiving the bid from the server computer, transmitting a bid acceptance from the computer of the TP to the server computer.

2. The method as set forth in claim 1, further including the steps of:
(i) in response to the server computer receiving the bid, transmitting from the server computer to the computer of the TB a confirmation of the bid acceptance;
(j) preparing at the server computer from data stored thereat a bid acceptance contract, said data including boilerplate contract provisions and at least the names of the TB and the TP; and
(k) transmitting the bid acceptance contract from the server computer to the computer of the TB and to the computer of the TP.

3. The method as set forth in claim 1, wherein step (d) includes the steps of:
comparing the available transportation capability of the TP and the transportation need of the TB based on at least one predetermined rule; and
determining that the available transportation capability of the TP fulfills the transportation need of the TB when the at least one predetermined rule is satisfied, but when there not a direct match between the available transportation capability of the TP and the transportation need of the TB.

4. A method of brokering freight transportation routes, the method comprising the steps of:
(a) receiving at a server computer from a computer of a transportation provider (TP) an available transportation capability of the TP;
(b) receiving at the server computer from a computer of a transportation buyer (TB) a transportation need of the TB;
(c) comparing at the server computer the available transportation capability of the TP and the transportation need of the TB;
(d) determining if the transportation needs of the TB is fulfilled by the available transportation capability of the TP;
(e) if the transportation need of the TB is fulfilled by the available transportation capability of the TP, transmitting from the server computer to the computer of the TP the transportation need of the TB;
(f) in response to receiving the transportation need of the TB, transmitting from the computer of the TP to the server computer a bid by the TP for the transportation need of the TB;
(g) forwarding the bid from the server computer to the computer of the TB; and
(h) in response to receiving the bid from the server computer, transmitting a bid acceptance from the computer of the TB to the server computer.

5. The method as set forth in claim 4, further including the steps of:
(i) in response to the server computer receiving the bid, transmitting from the server computer to the computer of the TP a confirmation of the bid acceptance;
(j) preparing at the server computer from data stored thereat a bid acceptance contract, said data including boilerplate contract provisions and at least the names of the TB and the TP; and
(k) transmitting the bid acceptance contract from the server computer to the computer of the TB and to the computer of the TP.

6. The method as set forth in claim 4, wherein step (d) includes the steps of:
comparing the available transportation capability of the TP and the transportation need of the TB based on at least one predetermined rule; and
determining that the transportation need of the TB is fulfilled by the available transportation capability of the TP when the at least one predetermined rule is satisfied, but when there not a direct match between the available transportation capability of the TP and the transportation need of the TB.

7. A method of brokering a warehouse space, the method comprising the steps of:
(a) receiving at a server computer from a computer of a warehouse space provider (WSP) an available warehouse space capability of the WSP;
(b) receiving at the server computer from a computer of a warehouse space buyer (WSB) a warehouse space need of the WSB;
(c) comparing at the server computer the available warehouse space capability of the WSP and the warehouse space need of the WSB;
(d) determining if the available warehouse space capability of the WSP fulfills the warehouse space need of the WSB;
(e) if the available warehouse space capability of the WSP fulfills the warehouse space need of the WSB, transmitting from the server computer to the computer of the WSB the available warehouse space capability of the WSP;
(f) in response to receiving the available warehouse space capability of the WSP, transmitting from the computer of the WSB to the server computer a bid by the WSB for the available warehouse space capability of the WSP;
(g) forwarding the bid from the server computer to the computer of the WSP; and
(h) in response to receiving the bid from the server computer, transmitting a bid acceptance from the computer of the WSP to the server computer.

8. The method as set forth in claim 7, further including the steps of:
(i) in response to the server computer receiving the bid, transmitting from the server computer to the computer of the WSB a confirmation of the bid acceptance;
(j) preparing at the server computer from data stored thereat a bid acceptance contract, said data including boilerplate contract provisions and at least the names of WSB and WSP.
(k) transmitting the bid acceptance contract from the server computer to the computer of the WSB and to the computer of the WSP.

9. The method as set forth in claim 7, wherein step (d) includes the steps of:
comparing the available warehouse space capability of the WSP and the warehouse space need of the TB based on at least one predetermined rule; and
determining that the available warehouse space capability of the WSP fulfills the warehouse space need of the WSB when the at least one predetermined rule is satisfied, but when there not a direct match between the available warehouse space capability of the WSP and the warehouse space need of the WSB.

10. A method of brokering a warehouse space, the method comprising the steps of:
(a) receiving at a server computer from a computer of a warehouse space provider (WSP) an available warehouse space capability of the WSP;
(b) receiving at the server computer from a computer of a warehouse space buyer (WSB) a warehouse space need of the WSB;
(c) comparing at the server computer the available warehouse space capability of the WSP and the warehouse space need of the WSB;
(d) determining if the available warehouse space need of the WSB is fulfilled by the warehouse space capability of the WSP;
(e) if the warehouse space need of the WSB is fulfilled by the available warehouse space capability of the WSP, transmitting from the server computer to the computer of the WSP the warehouse space need of the WSB;
(f) in response to receiving the warehouse space need of the WSB, transmitting from the computer of the WSP to the server computer a bid by the WSP for the warehouse space need of the WSB;
(g) forwarding the bid from the server computer to the computer of the WSB; and
(h) in response to receiving the bid from the server computer, transmitting a bid acceptance from the computer of the WSB to the server computer.

11. The method as set forth in claim 10, further including the steps of:
(i) in response to the server computer receiving the bid, transmitting from the server computer to the computer of the WSP a confirmation of the bid acceptance;
(j) preparing at the server computer from data stored thereat a bid acceptance contract, said data including boilerplate contract provisions and at least the names of WSB and WSP; and
(k) transmitting the bid acceptance contract from the server computer to the computer of the WSB and to the computer of the WSP.

12. The method as set forth in claim 10, wherein step (d) includes the steps of:
comparing the available warehouse space capability of the WSP and the warehouse space need of the WSB based on at least one predetermined rule; and
determining that the warehouse space need of the WSB is fulfilled by the available warehouse space capability of the WSP fulfills when the at least one predetermined rule is satisfied, but when there not a direct match between the available warehouse space capability of the WSP and the warehouse space need of the WSB.
